(19) United States
(12) Patent Application Publication
(10) Pub. No.: US 2020/0329895 A1
(43) Pub. Date: Oct. 22, 2020

(54) RETRACTABLE HOOK ASSEMBLY

(71) Applicant: UMBRA LLC, Buffalo, NY (US)

(72) Inventor: Martin Luu, Markham (CA)

(21) Appl. No.: 16/387,673

(22) Filed: Apr. 18, 2019

(51) Int. Cl. A47G 29/08; F16B 45/00

(52) U.S. Cl. CPC A47G 29/08; F16B 45/00

(57) ABSTRACT

A retractable hook assembly, comprising a base including at least one channel and a first hole, at least one hook at least partially arranged in the at least one channel, the at least one hook including a second hole, and a pin arranged to engage the first hole and the second hole to rotatably connect the at least one hook to the base.

### FIELD

The present disclosure relates to a retractable hook to display and organize apparel and the like, and more particularly, to a retractable hook assembly having one or more hooks.

### BACKGROUND

Hooks are often used in households, offices, restaurants, stores, and other places of business in order display and/or organize apparel or the like thereon. Hooks and other hanging devices are a convenient way to quickly hang a jacket up, for example. These hooks are often arranged near doors and doorways, since this is often ware jackets are removed and put on. However, often times, the hooks extend from the wall an undesired amount or are not aesthetically pleasing.

Thus, there is a long felt need for a retractable hook assembly having at least one hook that can be extended to hang items thereon and, alternatively, when not in use, be retracted to limit the overall space the assembly takes up and be more aesthetically pleasing.

### SUMMARY

According to aspects illustrated herein, there is provided a retractable hook assembly, comprising a base including at least one channel and a first hole, at least one hook at least partially arranged in the at least one channel, the at least one hook including a second hole, and a pin arranged to engage the first hole and the second hole to rotatably connect the at least one hook to the base.

According to aspects illustrated herein, there is provided a retractable hook assembly, comprising a base, including a front surface, a rear surface, a first side surface, a second side surface, at least one channel arranged in the front surface, and a first hole, at least one hook at least partially arranged in the at least one channel, the at least one hook including a second hole, and a pin arranged to engage the first hole and the second hole to rotatably connect the at least one hook to the base.

According to aspects illustrated herein, there is provided a retractable hook assembly, comprising a base, including a first hole, and at least one channel, the channel including a first surface, a tongue displaceable with respect to the first surface, and a protrusion arranged on the tongue, at least one hook at least partially arranged in the at least one channel, the at least one hook including a second hole, a first notch operatively arranged to engage the first protrusion when the at least one hook is in a retracted position, and a second notch arranged to engage the first protrusion when the at least one hook is in an extended position, and a pin arranged to engage the first hole and the second hole to rotatably connect the at least one hook to the base.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front perspective view of a retractable hook assembly in a retracted position;

FIG. 2 is a rear perspective view of the retractable hook assembly shown in FIG. 1;

FIG. 3 is a front perspective view of the retractable hook assembly shown in FIG. 1, in an extended position;

FIG. 4 is an exploded view of the retractable hook assembly shown in FIG. 3;

FIG. 5 is a detail view of the retractable hook assembly taken generally along detail 5 in FIG. 4;

FIG. 6 is a cross-sectional view of the retractable hook assembly taken generally along line 6-6 in FIG. 1;

FIG. 7 is a cross-sectional view of the retractable hook assembly taken generally along line 7-7 in FIG. 3;

FIG. 8A is a front perspective view of a hook; and,

FIG. 8B is a rear perspective view of the hook shown in FIG. 8A.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

By “non-rotatably connected” elements, we mean that: the elements are connected so that whenever one of the elements rotate, all the elements rotate; and relative rotation between the elements is not possible. Radial and/or axial movement of non-rotatably connected elements with respect to each other is possible, but not required. By “rotatably connected” elements, we mean that the elements are rotatable with respect to each other.

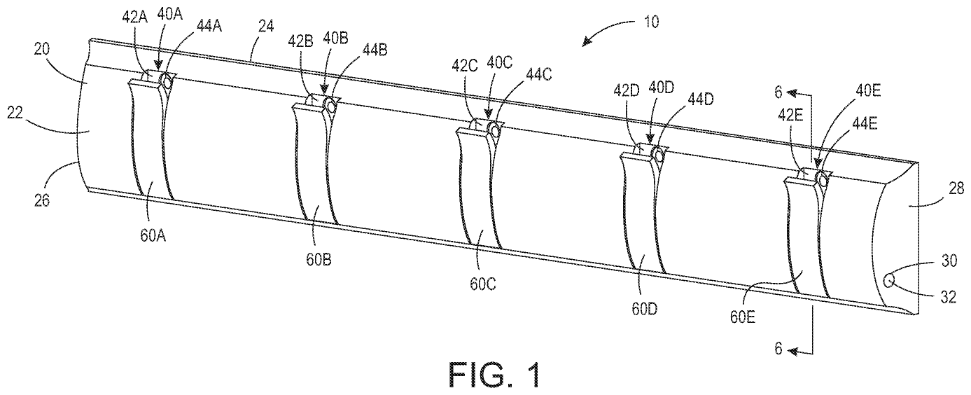

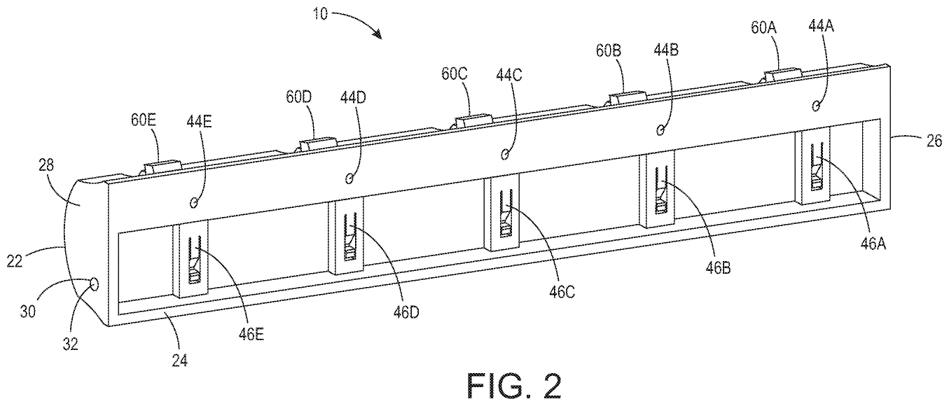

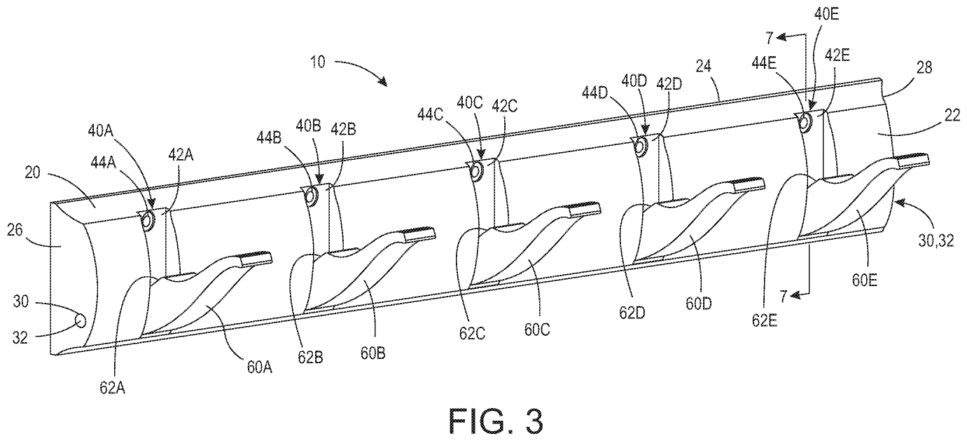

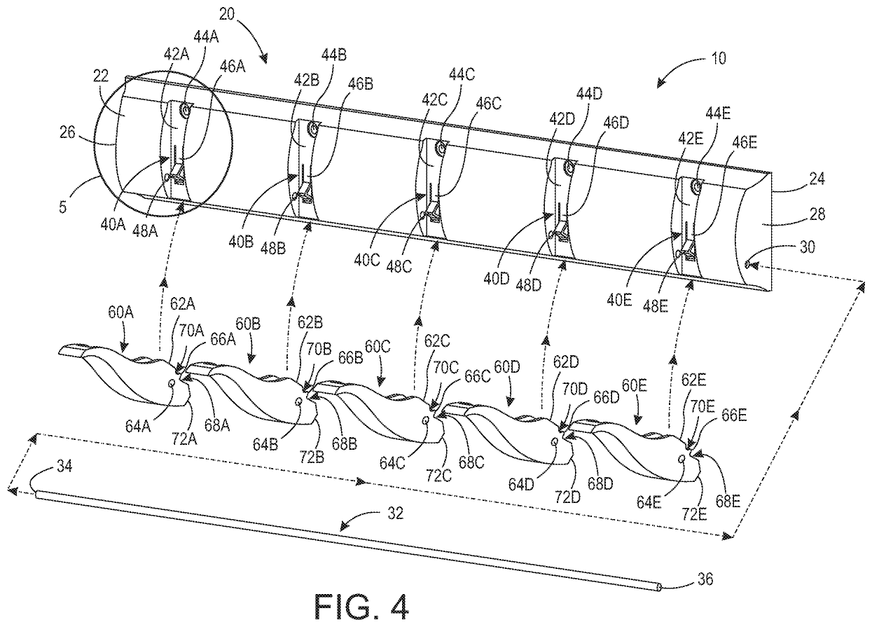

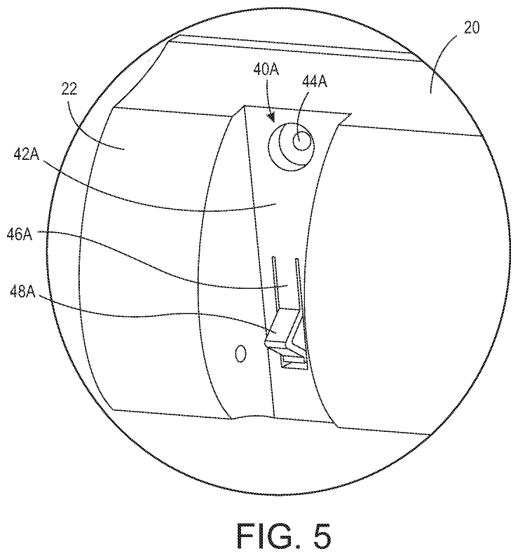

Referring now to the figures, FIG. 1 is a front perspective view of retractable hook assembly 10 in a retracted position. FIG. 2 is a rear perspective view of retractable hook assembly 10. FIG. 3 is a front perspective view of retractable hook assembly 10 in an extended position. FIG. 4 is an exploded view of retractable hook assembly 10. FIG. 5 is a detail view of retractable hook assembly 10 taken generally along detail 5 in FIG. 4. Retractable hook assembly 10 comprises base 20, pin 32, and one or more hooks, for example, hooks 60A-E. It should be appreciated that by retracted position, it is meant that hooks 60A-E and 160 are arranged in close proximity with base 20 and thus do not allow for clothing and other materials to be hung thereon. It should be appreciated that by extended position, it is meant that hooks 60A-E and 160 adequately extend from base 20 and allow for clothing and other materials to be hung thereon. The following description should be read in view of FIGS. 1-5.

Base 20 comprises front surface 22, rear surface 24, side surface 26, side surface 28, hole 30, and one or more channels, for example channels 40A-E. Front surface 22 is a curvilinear surface with one or more channels arranged therein. In some embodiments, front surface 22 is planar. In the embodiment shown, base 20 comprises five channels 40A-E. It should be appreciated, however, that base 20 may comprise any number of channels to support any number of hooks (e.g., base 20 may comprise one or more channels to support one or more hooks). Rear surface 24 is generally planar and is arranged to abut against or be in close proximity to a wall or a hanging surface on which retractable hook assembly 10 is connected or mounted. In some embodiments, rear surface 24 comprises one or more cutouts to reduce the amount of material in base 20. Side surface 26 is planar and may be tapered (i.e., side surface 26 may be arranged at an angle relative to rear surface 24). In some embodiments, side surface 26 is arranged perpendicular to rear surface 24. Side surface 28 is planar and may be tapered (i.e., side surface 28 may be arranged at an angle relative to rear surface 24). In some embodiments, side surface 28 is arranged perpendicular to rear surface 24. Hole 30 extends from side surface 26 to side surface 28. Pin 32 comprises end 34 and end 36 and is operatively arranged to engage hole 30. In some embodiments, when fully assembled, end 34 is arranged proximate side surface 26 and end 36 is arranged proximate side surface 28. Pin 32 is operatively arranged to rotatably connect hooks 60A-E to base 20 in channels 40A-E, respectively. In some embodiments, pin 32 is engaged with hole 30 via a press or interference fit such that pin 32 is non-rotatably connected to base 60. In some embodiments, pin 32 is rotatable within hole 30.

Channel 40A comprises surface 42A, hole 44A, and tongue 46A. Hole 44A extends from surface 42A to rear surface 24 such that a screw can extend through hole 44A to connect base 20 to a mounting surface. In some embodiments, hole 44A extends through base 20 at any location thereon to connect base 20 to a mounting surface. In some embodiments, hole 44A comprises a counter-bore. Tongue 46A is a flexible portion of base 20. Specifically, tongue 46A is operatively arranged to displace relative to surface 42A, specifically, toward rear surface 24, to engage/disengage notches 68A and 70A of hook 60A, as will be discussed in greater detail below. Tongue 46A comprises protrusion 48A, which is arranged to engage notches 68A and 70A to lock hook 60A in the retracted and extended positions, respectively. In some embodiments, tongue 46A comprises an elastic material, such as acrylonitrile butadiene styrene (ABS).

Channel 40B comprises surface 42B, hole 44B, and tongue 46B. Hole 44B extends from surface 42B to rear surface 24 such that a screw can extend through hole 44B to connect base 20 to a mounting surface. In some embodiments, hole 44B extends through base 20 at any location thereon to connect base 20 to a mounting surface. In some embodiments, hole 44B comprises a counter-bore. Tongue 46B is a flexible portion of base 20. Specifically, tongue 46B is operatively arranged to displace relative to surface 42B, specifically, toward rear surface 24, to engage/disengage notches 68B and 70B of hook 60B, as will be discussed in greater detail below. Tongue 46B comprises protrusion 48B, which is arranged to engage notches 68B and 70B to lock hook 60B in the retracted and extended positions, respectively. In some embodiments, tongue 46B comprises an elastic material, such as ABS.

Channel 40C comprises surface 42C, hole 44C, and tongue 46C. Hole 44C extends from surface 42C to rear surface 24 such that a screw can extend through hole 44C to connect base 20 to a mounting surface. In some embodiments, hole 44C extends through base 20 at any location thereon to connect base 20 to a mounting surface. In some embodiments, hole 44C comprises a counter-bore. Tongue 46C is a flexible portion of base 20. Specifically, tongue 46C is operatively arranged to displace relative to surface 42C, specifically, toward rear surface 24, to engage/disengage notches 68C and 70C of hook 60C, as will be discussed in greater detail below. Tongue 46C comprises protrusion 48C, which is arranged to engage notches 68C and 70C to lock hook 60C in the retracted and extended positions, respectively. In some embodiments, tongue 46C comprises an elastic material, such as ABS.

Channel 40D comprises surface 42D, hole 44D, and tongue 46D. Hole 44D extends from surface 42D to rear surface 24 such that a screw can extend through hole 44D to connect base 20 to a mounting surface. In some embodiments, hole 44D extends through base 20 at any location thereon to connect base 20 to a mounting surface. In some embodiments, hole 44D comprises a counter-bore. Tongue 46D is a flexible portion of base 20. Specifically, tongue 46D is operatively arranged to displace relative to surface 42D, specifically, toward rear surface 24, to engage/disengage notches 68D and 70D of hook 60D, as will be discussed in greater detail below. Tongue 46D comprises protrusion 48D, which is arranged to engage notches 68D and 70D to lock hook 60D in the retracted and extended positions, respectively. In some embodiments, tongue 46D comprises an elastic material, such as ABS.

Channel 40E comprises surface 42E, hole 44E, and tongue 46E. Hole 44E extends from surface 42E to rear surface 24 such that a screw can extend through hole 44E to connect base 20 to a mounting surface. In some embodiments, hole 44E extends through base 20 at any location thereon to connect base 20 to a mounting surface. In some embodiments, hole 44E comprises a counter-bore. Tongue 46E is a flexible portion of base 20. Specifically, tongue 46E is operatively arranged to displace relative to surface 42E, specifically, toward rear surface 24, to engage/disengage notches 68E and 70E of hook 60E, as will be discussed in greater detail below. Tongue 46E comprises protrusion 48E, which is arranged to engage notches 68E and 70E to lock hook 60E in the retracted and extended positions, respectively. In some embodiments, tongue 46E comprises an elastic material, such as ABS plastic.

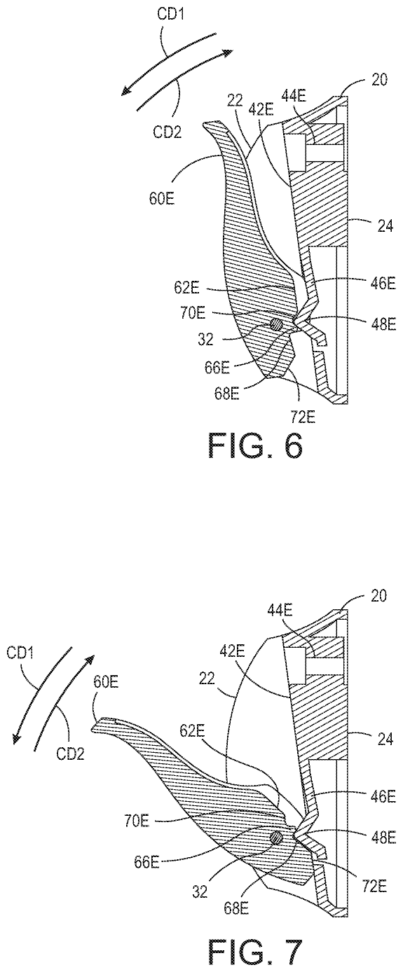

Hook 60A comprises surface 62A, hole 64A, protrusion 66A, notch 68A, notch 70A, and surface 72A. Hole 64A is operatively arranged to rotatably engage pin 32. In some embodiments, hole 64A comprises a bearing. Protrusion 66A separates notches 68A and 70A. Notch 70A is generally an indentation in hook 60A operatively arranged to engage protrusion 48A when hook 60A is in a retracted position. Notch 68A is generally an indentation in hook 60A operatively arranged to engage protrusion 48A when hook 60A is in an extended position. In the retracted position, the engagement of protrusion 48A with notch 70A and protrusion 66A maintains hook 60A in the retracted position. When a sufficient amount of force is applied to hook 60A, hook 60A rotates about pin 32 and protrusion 66A forces protrusion 48A to displace with respect to surface 42A. Once hook 60A is rotated a sufficient amount, protrusion 66A disengages protrusion 48A allowing protrusion 48A to engage notch 68A (i.e., in the extended position). In the extended position, the engagement of protrusion 48A with notch 68A and protrusion 66A maintains hook 60A in the retracted position, until sufficient force is applied to overcome it. Surface 62A is operatively arranged to abut against or be arranged proximate to surface 42A when hook 60A is in the retracted position (see FIG. 6). Surface 62A thus may act as a stop, preventing and/or discouraging over rotation of hook 60A relative to base 20. Surface 72A is operatively arranged to abut against or be arranged proximate to surface 42A when hook 60A is in the extended position (see FIG. 7). Surface 72A thus may act as a stop, preventing and/or discouraging over rotation of hook 60A relative to base 20.

Hook 60B comprises surface 62B, hole 64B, protrusion 66B, notch 68B, notch 70B, and surface 72B. Hole 64B is operatively arranged to rotatably engage pin 32. In some embodiments, hole 64B comprises a bearing. Protrusion 66B separates notches 68B and 70B. Notch 70B is generally an indentation in hook 60B operatively arranged to engage protrusion 48B when hook 60B is in a retracted position. Notch 68B is generally an indentation in hook 60B operatively arranged to engage protrusion 48B when hook 60B is in an extended position. In the retracted position, the engagement of protrusion 48B with notch 70B and protrusion 66B maintains hook 60B in the retracted position. When a sufficient amount of force is applied to hook 60B, hook 60B rotates about pin 32 and protrusion 66B forces protrusion 48B to displace with respect to surface 42B. Once hook 60B is rotated a sufficient amount, protrusion 66B disengages protrusion 48B allowing protrusion 48B to engage notch 68B (i.e., in the extended position). In the extended position, the engagement of protrusion 48B with notch 68B and protrusion 66B maintains hook 60B in the retracted position, until sufficient force is applied to overcome it. Surface 62B is operatively arranged to abut against or be arranged proximate to surface 42B when hook 60B is in the retracted position (see FIG. 6). Surface 62B thus may act as a stop, preventing and/or discouraging over rotation of hook 60B relative to base 20. Surface 72B is operatively arranged to abut against or be arranged proximate to surface 42B when hook 60B is in the extended position (see FIG. 7). Surface 72B thus may act as a stop, preventing and/or discouraging over rotation of hook 60B relative to base 20.

Hook 60C comprises surface 62C, hole 64C, protrusion 66C, notch 68C, notch 70C, and surface 72C. Hole 64C is operatively arranged to rotatably engage pin 32. In some embodiments, hole 64C comprises a bearing. Protrusion 66C separates notches 68C and 70C. Notch 70C is generally an indentation in hook 60C operatively arranged to engage protrusion 48C when hook 60C is in a retracted position. Notch 68C is generally an indentation in hook 60C operatively arranged to engage protrusion 48C when hook 60C is in an extended position. In the retracted position, the engagement of protrusion 48C with notch 70C and protrusion 66C maintains hook 60C in the retracted position. When a sufficient amount of force is applied to hook 60C, hook 60C rotates about pin 32 and protrusion 66C forces protrusion 48C to displace with respect to surface 42C. Once hook 60C is rotated a sufficient amount, protrusion 66C disengages protrusion 48C allowing protrusion 48C to engage notch 68C (i.e., in the extended position). In the extended position, the engagement of protrusion 48C with notch 68C and protrusion 66C maintains hook 60C in the retracted position, until sufficient force is applied to overcome it. Surface 62C is operatively arranged to abut against or be arranged proximate to surface 42C when hook 60C is in the retracted position (see FIG. 6). Surface 62C thus may act as a stop, preventing and/or discouraging over rotation of hook 60C relative to base 20. Surface 72C is operatively arranged to abut against or be arranged proximate to surface 42C when hook 60C is in the extended position (see FIG. 7). Surface 72C thus may act as a stop, preventing and/or discouraging over rotation of hook 60C relative to base 20.

Hook 60D comprises surface 62D, hole 64D, protrusion 66D, notch 68D, notch 70D, and surface 72D. Hole 64D is operatively arranged to rotatably engage pin 32. In some embodiments, hole 64D comprises a bearing. Protrusion 66D separates notches 68D and 70D. Notch 70D is generally an indentation in hook 60D operatively arranged to engage protrusion 48D when hook 60D is in a retracted position. Notch 68D is generally an indentation in hook 60D operatively arranged to engage protrusion 48D when hook 60D is in an extended position. In the retracted position, the engagement of protrusion 48D with notch 70D and protrusion 66D maintains hook 60D in the retracted position. When a sufficient amount of force is applied to hook 60D, hook 60D rotates about pin 32 and protrusion 66D forces protrusion 48D to displace with respect to surface 42D. Once hook 60D is rotated a sufficient amount, protrusion 66D disengages protrusion 48D allowing protrusion 48D to engage notch 68D (i.e., in the extended position). In the extended position, the engagement of protrusion 48D with notch 68D and protrusion 66D maintains hook 60D in the retracted position, until sufficient force is applied to overcome it. Surface 62D is operatively arranged to abut against or be arranged proximate to surface 42D when hook 60D is in the retracted position (see FIG. 6). Surface 62D thus may act as a stop, preventing and/or discouraging over rotation of hook 60D relative to base 20. Surface 72D is operatively arranged to abut against or be arranged proximate to surface 42D when hook 60D is in the extended position (see FIG. 7). Surface 72D thus may act as a stop, preventing and/or discouraging over rotation of hook 60D relative to base 20.

Hook 60E comprises surface 62E, hole 64E, protrusion 66E, notch 68E, notch 70E, and surface 72E. Hole 64E is operatively arranged to rotatably engage pin 32. In some embodiments, hole 64E comprises a bearing. Protrusion 66E separates notches 68E and 70E. Notch 70E is generally an indentation in hook 60E operatively arranged to engage protrusion 48E when hook 60E is in a retracted position. Notch 68E is generally an indentation in hook 60E operatively arranged to engage protrusion 48E when hook 60E is in an extended position. In the retracted position, the engagement of protrusion 48E with notch 70E and protrusion 66E maintains hook 60E in the retracted position. When a sufficient amount of force is applied to hook 60E, hook 60E rotates about pin 32 and protrusion 66E forces protrusion 48E to displace with respect to surface 42E. Once hook 60E is rotated a sufficient amount, protrusion 66E disengages protrusion 48E allowing protrusion 48E to engage notch 68E (i.e., in the extended position). In the extended position, the engagement of protrusion 48E with notch 68E and protrusion 66E maintains hook 60E in the retracted position, until sufficient force is applied to overcome it. Surface 62E is operatively arranged to abut against or be arranged proximate to surface 42E when hook 60E is in the retracted position (see FIG. 6). Surface 62E thus may act as a stop, preventing and/or discouraging over rotation of hook 60E relative to base 20. Surface 72E is operatively arranged to abut against or be arranged proximate to surface 42E when hook 60E is in the extended position (see FIG. 7). Surface 72E thus may act as a stop, preventing and/or discouraging over rotation of hook 60E relative to base 20.

FIG. 6 is a cross-sectional view of retractable hook assembly 10 taken generally along line 6-6 in FIG. 1. It should be appreciated that although FIG. 6 is described with respect to hook 60E, the description also applies to hooks 60A-D. As shown, hook 60E is in the retracted position. Specifically, protrusion 48A is engaged with notch 70E and protrusion 66E, and surface 62E abuts against or is arranged in close proximity to surface 42E. While the engagement of protrusion 48A with notch 70E and protrusion 66E maintains hook 60E in the retracted position, the interaction and/or engagement of surface 62E with surface 42E prevents hook 60E from being over rotated in circumferential direction CD2, which would put unwanted strain on pin 32. To change hook 60E from the retracted position shown in FIG. 6 to the extended position shown in FIG. 7, a sufficient force is applied to hook 60E to rotate hook 60E in circumferential direction CD1.

FIG. 7 is a cross-sectional view of retractable hook assembly 10 taken generally along line 7-7 in FIG. 3. It should be appreciated that although FIG. 7 is described with respect to hook 60E, the description also applies to hooks 60A-D. As shown, hook 60E is in the extended position. Specifically, protrusion 48A is engaged with notch 68E and protrusion 66E, and surface 72E abuts against or is arranged in close proximity to surface 42E. While the engagement of protrusion 48A with notch 68E and protrusion 66E maintains hook 60E in the extended position, the interaction and/or engagement of surface 72E with surface 42E prevents hook 60E from being over rotated in circumferential direction CD1, which would put unwanted strain on pin 32. To change hook 60E from the extended position shown in FIG. 7 to the retracted position shown in FIG. 6, a sufficient force is applied to hook 60E to rotate hook 60E in circumferential direction CD2.

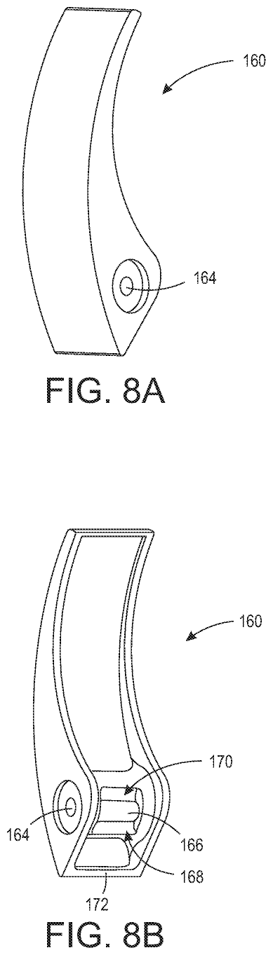

FIG. 8A is a front perspective view of hook 160. FIG. 8B is a rear perspective view of hook 160. Hook 160 may be used as a replacement for or in addition to any of hooks 160A-E in retractable hook assembly 10, as shown in FIGS. 1-7. Hook 160 comprises hole 164, protrusion 166, notch 168, notch 170, and surface 172. Hole 164 is operatively arranged to rotatably engage pin 32. In some embodiments, hole 164 comprises a bearing. Protrusion 166 separates notches 168 and 170. Notch 170 is generally an indentation in hook 160 operatively arranged to engage protrusions 48A-E when hook 160 is in a retracted position. Notch 168 is generally an indentation in hook 160 operatively arranged to engage protrusions 48A-E when hook 160 is in an extended position. In the retracted position, the engagement of one of protrusions 48A-E with notch 170 and protrusion 166 maintains hook 160 in the retracted position. When a sufficient amount of force is applied to hook 160, hook 160 rotates about pin 32 and protrusion 166 forces the one of protrusions 48A-E to displace with respect to the respective surface of surfaces 42A-E. Once hook 160 is rotated a sufficient amount, protrusion 166 disengages the one of protrusions 48A-E allowing the one of protrusion 48A-E to engage notch 168 (i.e., in the extended position). In the extended position, the engagement of one of protrusions 48A-E with notch 168 and protrusion 166 maintains hook 160 in the retracted position, until sufficient force is applied to overcome it. Surface 172 is operatively arranged to abut against or be arranged proximate to respective surfaces 42A-E when hook 160 is in the extended position (similar to as shown in FIG. 7). Surface 172 thus may act as a stop, preventing and/or discouraging over rotation of hook 160 relative to base 20.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Retractable hook assembly
20 Base
22 Front surface
24 Rear surface
26 Side surface
28 Side surface
30 Hole
32 Pin
34 End
36 End
40A Channel
40B Channel
40C Channel
40D Channel
40E Channel
42A Surface
42B Surface
42C Surface
42D Surface
42E Surface
44A Hole
44B Hole
44C Hole
44D Hole
44E Hole
46A Tongue
46B Tongue
46C Tongue
46D Tongue
46E Tongue
48A Protrusion
48B Protrusion
48C Protrusion
48D Protrusion
48E Protrusion
60A Hook
60B Hook
60C Hook
60D Hook
60E Hook
62A Surface
62B Surface
62C Surface
62D Surface
62E Surface
64A Hole
64B Hole
64C Hole
64D Hole
64E Hole
66A Protrusion
66B Protrusion
66C Protrusion
66D Protrusion
66E Protrusion
68A Notch
68B Notch
68C Notch
68D Notch
68E Notch
70A Protrusion
70B Protrusion
70C Protrusion
70D Protrusion
70E Protrusion
72A Surface
72B Surface
72C Surface
72D Surface
72E Surface
160 Hook
164 Hole
166 Protrusion
168 Notch
170 Notch
172 Surface
CD1 Circumferential direction
CD2 Circumferential direction

What is claimed is:

1. A retractable hook assembly, comprising:
a base including at least one channel and a first hole;
at least one hook at least partially arranged in the at least one channel, the at least one hook including a second hole; and,
a pin arranged to engage the first hole and the second hole to rotatably connect the at least one hook to the base.

2. The retractable hook assembly as recited in claim 1, wherein the at least one channel comprises:
a first surface; and,
a tongue displaceable with respect to the first surface.

3. The retractable hook assembly as recited in claim 2, wherein the tongue comprises a first protrusion.

4. The retractable hook assembly as recited in claim 3, wherein the at least one hook further comprises:
a first notch arranged to engage the first protrusion when the at least one hook is in a retracted position; and,
a second notch arranged to engage the first protrusion when the at least one hook is in an extended position.

5. The retractable hook assembly as recited in claim 4, wherein the at least one hook further comprises a second protrusion arranged between the first notch and the second notch.

6. The retractable hook assembly as recited in claim 4, wherein the at least one hook further comprises a second surface operatively arranged to engage the first surface.

7. The retractable hook assembly as recited in claim 6, wherein the second surface acts as a stop when the at least one hook is in the retracted position.

8. The retractable hook assembly as recited in claim 6, wherein the at least one hook further comprises a third surface operatively arranged to engage the first surface.

9. The retractable hook assembly as recited in claim 8, wherein the third surface acts as a stop when the at least one hook is in the extended position.

10. The retractable hook assembly as recited in claim 1, wherein the base further comprises at least one mounting hole operatively arranged to connect the base to a mounting surface.

11. The retractable hook assembly as recited in claim 10, wherein the at least one mounting hole is arranged in the at least one channel.

12. A retractable hook assembly, comprising:
a base, including:
a front surface;
a rear surface;
a first side surface;
a second side surface;
at least one channel arranged in the front surface; and,
a first hole;
at least one hook at least partially arranged in the at least one channel, the at least one hook including a second hole; and,
a pin arranged to engage the first hole and the second hole to rotatably connect the at least one hook to the base.

13. The retractable hook assembly as recited in claim 12, wherein the at least one channel comprises:
a first surface; and,
a tongue displaceable with respect to the first surface, the tongue including a first protrusion.

14. The retractable hook assembly as recited in claim 13, wherein the at least one hook further comprises:
a first notch arranged to engage the first protrusion when the at least one hook is in a retracted position; and,
a second notch arranged to engage the first protrusion when the at least one hook is in an extended position.

15. The retractable hook assembly as recited in claim 14, wherein the at least one hook further comprises a second protrusion arranged between the first notch and the second notch.

16. The retractable hook assembly as recited in claim 14, wherein the at least one hook further comprises a second surface operatively arranged to engage the first surface.

17. The retractable hook assembly as recited in claim 16, wherein the at least one hook further comprises a third surface operatively arranged to engage the first surface.

18. The retractable hook assembly as recited in claim 12, wherein the base further comprises at least one mounting hole operatively arranged to connect the base to a mounting surface.

19. The retractable hook assembly as recited in claim 18, wherein the at least one mounting hole is arranged in the at least one channel.

20. A retractable hook assembly, comprising:
a base, including:
a first hole; and,
at least one channel, the channel including a first surface, a tongue displaceable with respect to the first surface, and a protrusion arranged on the tongue;
at least one hook at least partially arranged in the at least one channel, the at least one hook including:
a second hole;
a first notch operatively arranged to engage the first protrusion when the at least one hook is in a retracted position; and,
a second notch arranged to engage the first protrusion when the at least one hook is in an extended position; and,
a pin arranged to engage the first hole and the second hole to rotatably connect the at least one hook to the base.
